(19) United States
(12) Patent Application Publication
(10) Pub. No.: US 2026/0317575 A1
(43) Pub. Date: Oct. 15, 2026

(54) AZEOTROPIC AND NON-AZEOTROPIC HYDROFLUORO OLEFIN FORMULATIONS AND USES

(71) Applicant: Illinois Tool Works Inc., Glenview, IL (US)

(72) Inventor: Paul M. Blair, Jonesboro, GA (US)

(21) Appl. No.: 19/706,847

(22) Filed: Jun. 12, 2026

Related U.S. Application Data
(63) Continuation-in-part of application No. 19/413,178, filed on Dec. 9, 2025.
(60) Provisional application No. 63/734,525, filed on Dec. 16, 2024.

(51) Int. Cl. C09D 127/12; C09D 7/20; C09K 5/00; C11D 7/30; C11D 7/50; C11D 17/00

(52) U.S. Cl. CPC C09D 127/12; C09D 7/20; C09K 5/00; C11D 7/30; C11D 7/5018; C11D 7/5022; C11D 17/0043

(57) ABSTRACT

The present disclosure relates generally to azeotropic and non-azeotropic hydrofluoro olefin formulations, particularly formulations including cis-1-Chloro-3,3,3-trifluoropropene, also known as HFO-1233zd(Z), for applications including vapor degreasing, non-flammable aerosol cleaning, swelling solvents, liquid oxygen service line cleaning, carrier and deposition solvents, and metal working fluids.

### CROSS-REFERENCE TO RELATED APPLICATIONS

This application is a continuation-in-part of U.S. patent application Ser. No. 19/413,178, entitled “Azeotropic and Non-Azeotropic Hydrofluoro Olefin Formulations and Uses,” filed Dec. 9, 2025, which claims the benefit of priority to U.S. Provisional Patent Application Ser. No. 63/734,525, entitled “Azeotropic and Non-Azeotropic Hydrofluoro Olefin Formulations and Uses”, filed Dec. 16, 2024, the contents of which are herein incorporated by reference in their entireties.

### FIELD

The present disclosure relates generally to azeotropic and non-azeotropic hydrofluoro olefin formulations and uses, particularly formulations including cis-1-Chloro-3,3,3-trifluoropropene, also known as HFO-1233zd(Z).

### BACKGROUND

1-Chloro-3,3,3-trifluoropropene (HFO-1233zd) is an unsaturated chlorofluorocarbon that has the chemical formula HCIC═C(H)CF₃. HFO-1233zd exists as Z- (cis-) and E- (trans-) isomers. The trans-isomer, HFO-1233zd(E), has become of some interest as a more environmentally friendly refrigerant, since it has a lower global warming potential or GWP than certain existing refrigerants. Both HFO-1233zd isomers may be prepared by fluorination and dehydrohalogenation reactions starting with 1,1,1,3,3-pentachloropropane.

While there has been some interest in HFO-1233zd(E) as a more environmentally friendly refrigerant, formulations containing HFO-1233zd(Z) may also have potential, and are explored in the present disclosure. As such, there exists a need for formulations containing HFO-1233zd(Z) and uses for these formulations.

### SUMMARY

According to an aspect of the present disclosure, a vapor degreasing solution may comprise trans-1,2-dichloroethylene and cis-1-Chloro-3,3,3-trifluoropropene. The vapor degreasing solution may further comprise methanol.

According to another aspect of the present disclosure, a non-flammable aerosol cleaning solution may comprise trans-1,2-dichloroethylene, cis-1-Chloro-3,3,3-trifluoropropene, and trans-1,3,3,3-tetrafluoropropene. The non-flammable aerosol cleaning solution may further comprise ethanol, or carbon dioxide, or both.

According to another aspect of the present disclosure, a swelling solvent may comprise cis-1-Chloro-3,3,3-trifluoropropene. The swelling solvent may further comprise heptane, or trans-1-Chloro-3,3,3-trifluoropropene, or both.

According to another aspect of the present disclosure, a liquid oxygen service line cleaning fluid may comprise cis-1-Chloro-3,3,3-trifluoropropene.

According to another aspect of the present disclosure, a carrier and deposition solvent for fluoropolymer (fluorinated acrylate) coatings may comprise cis-1-Chloro-3,3,3-trifluoropropene.

According to another aspect of the present disclosure, a carrier and deposition solvent for solid pesticides may comprise cis-1-Chloro-3,3,3-trifluoropropene. The carrier and deposition solvent for solid pesticides may be applied to inert particles. The inert particles may be made of gypsum.

According to another aspect of the present disclosure, a metal working fluid for cooling cutting and drilling operations may comprise cis-1-Chloro-3,3,3-trifluoropropene. The metal working fluid may further comprise dodecanoate.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

FIG. 1 illustrates a skeletal structural formula of cis-1-Chloro-3,3,3-trifluoropropene, also known as HFO-1233zd(Z).

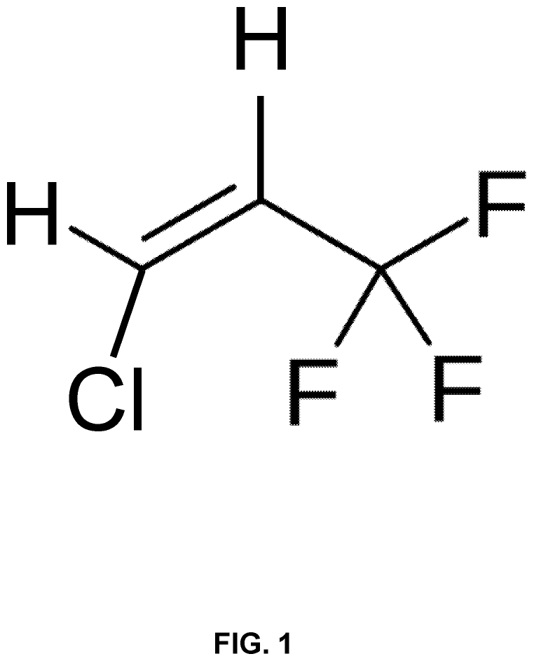

FIG. 2 illustrates a skeletal structural formula of trans-1-Chloro-3,3,3-trifluoropropene, also known as HFO-1233zd(E).

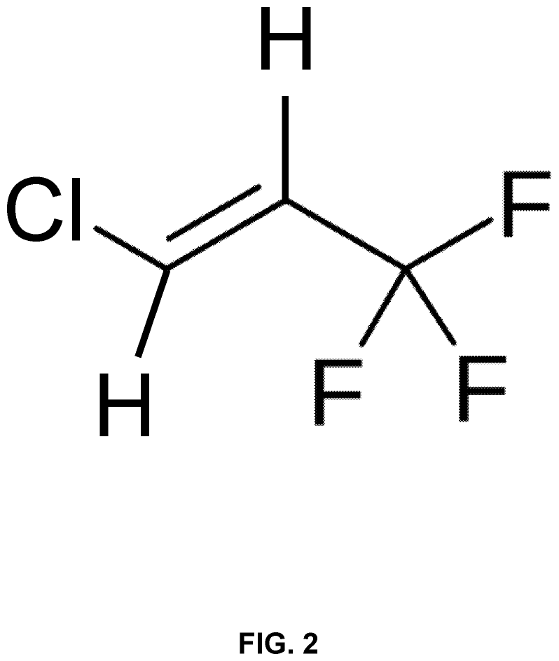

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Cis-1-Chloro-3,3,3-trifluoropropene, also known as HFO-1233zd(Z) is a nonflammable organic solvent. Its ultra low global warming potential (GWP) of less than 1 makes it an environmental friendly solvent candidate in various industry applications, including electronic cleaning. Due to its boiling point of 39° C. and Kb value, HFO-1233zd(Z) can be used in vapor degreasing and aerosol cleaning applications.

According to certain aspects of the present disclosure, a solution for applying a coating may comprise a fluoropolymer coating; and a carrier and deposition solvent for the fluoropolymer coating, wherein the carrier and deposition solvent comprises cis-1-chloro-3,3,3-trifluoropropene. In certain embodiments, the fluoropolymer coating may comprise fluorinated acrylate, perfluoropolyether, polychlorotrifluoroethylene, a fluorinated carbonate, a fluorinated polyester, polyvinylidene fluoride, fluoroethylene vinyl ether, or a homopolymer of perfluoro (4-vinyloxy-1-butene).

According to certain aspects of the present disclosure, a method of making a coating solution may comprise dissolving a fluoropolymer coating into a carrier and deposition solvent comprising cis-1-chloro-3,3,3-trifluoropropene.

According to certain aspects of the present disclosure, a method of using a coating solution may comprise applying a coating solution to a surface, the coating solution comprising a carrier and deposition solvent comprising cis-1-chloro-3,3,3-trifluoropropene and a fluoropolymer coating; and evaporating the carrier and deposition solvent to form a coating on the surface. In some embodiments, the surface may be a hard drive. In some embodiments, applying the coating solution may be performed by dip coating. In some embodiments, applying the coating solution may be performed by spin coating. In some embodiments, applying the coating solution may be performed by spraying the coating.

### Vapor Degreasing.

According to certain aspects of the present disclosure, a vapor degreasing solution may comprise cis-1-Chloro-3,3,3-trifluoropropene and methanol. In certain embodiments, such a vapor degreasing solution may comprise 90-99, or 95-98, or 96-97 wt. % cis-1-Chloro-3,3,3-trifluoropropene and 1-10, or 2-5, or 3-4 wt. % methanol. The boiling point of this solution may be approximately 38° C. Combining HFO1233zd(Z) with methanol may add polarity and hydrogen bonding characteristics that improve the ability of the composition to remove polar contaminants such as soldering fluxes, some hydraulic fluids, and machining fluids. The azeotropic composition remains nonflammable.

According to certain aspects of the present disclosure, a vapor degreasing solution may comprise trans-1,2-dichloroethylene and cis-1-Chloro-3,3,3-trifluoropropene. In certain embodiments, such a vapor degreasing solution may comprise 65-90, or 70-85, or 75-80 wt. % trans-1,2-dichloroethylene and 10-35, or 15-30, or 20-25 wt. % cis-1-Chloro-3,3,3-trifluoropropene. An example vapor degreasing solution and its effectiveness in removing certain soils is shown in Table 1. In certain embodiments, the vapor degreasing solution may further comprise methanol.

TABLE 1
Example vapor degreasing solution comprising trans-1,2-dichloroethylene
and cis-1-Chloro-3,3,3-trifluoropropene (HFO1233zd(Z)).

| | 22% trans-1,2-dichloroethylene/ |
|---|---|
| Soil | 78% HFO1233zd(Z) |
| Fingerprint | Completely Removed |
| Motor Oil | Completely Removed |
| Chain Lube | Completely Removed |
| All Purpose Grease | Completely Removed |
| Petrolatum | Completely Removed |
| Silicone Fluid | Completely Removed |
| Skydrol Flux | Completely Removed |
| Kester Flux | Completely Removed |

According to certain aspects of the present disclosure, a vapor degreasing solution may comprise cis-1-Chloro-3,3,3-trifluoropropene, trans-1,2-dichloroethylene, and methanol. Such a solution may be considered a binary azeotrope (two azeotropes blended). In certain embodiments, a vapor degreasing solution may comprise 0-5, or 1-4, or 3 wt. % methanol, and 20-30, or 21-25, or 22 wt. % trans-1,2-dichloroethylene and 70-80, or 72-78, or 75 wt. % cis-1-Chloro-3,3,3-trifluoropropene. An example vapor degreasing solution and its effectiveness in removing certain soils is shown in Table 2.

TABLE 2
Example solution comprising methanol, trans-1,2-dichloroethylene,
and cis-1-Chloro-3,3,3-trifluoropropene.

| | 3% Methanol/22% trans-1,2-dichloroethylene/ |
|---|---|
| Soil | 75% HFO1233zd(Z) |
| Fingerprint | Completely Removed |
| Motor Oil | Completely Removed |
| Chain Lube | Completely Removed |
| All Purpose Grease | Completely Removed |
| Petrolatum | Completely Removed |
| Silicone Fluid | Completely Removed |
| Skydrol Hydraulic Fluid | Completely Removed |
| Kester Flux | Completely Removed |
| Indium 3.2 Flux | Mostly Removed |
| Indium 8.9 HF Flux | Some Removed |

According to certain aspects of the present disclosure, a vapor degreasing solution may comprise 75-99, or 80-95, or 85-90 wt. % trans-1,2-dichloroethylene and 1-25, or 4-20, or 9-15 wt. % cis-1-Chloro-3,3,3-trifluoropropene. In certain other embodiments, a vapor degreasing solution may comprise 80-90 or 90-95 wt. % trans-1,2-dichloroethylene and 4-10 or 10-20 wt. % cis-1-Chloro-3,3,3-trifluoropropene. In certain embodiments, such a solution may be considered a near-non- or pseudo-azeotrope. The boiling point of this solution may be approximately 38° C. Combining HFO1233zd(Z) with trans-1,2-dichloroethylene may increase solvency which improves the ability of the composition to remove a wide variety of contaminants such as soldering fluxes, some hydraulic fluids, oils and greases, some coatings, and excess adhesives. The azeotropic composition remains nonflammable.

According to certain aspects of the present disclosure, a vapor degreasing solution may comprise cis-1-Chloro-3,3,3-trifluoropropene and one or more of the following solvents, all designed to keep the boiling point of the vapor degreasing solution between 25° C. and 65° C.: acetone, cyclopentane, isopentane, ethyl formate, methyl formate, and methyl acetate.

### Aerosol Cleaning.

According to certain aspects of the present disclosure, a non-flammable aerosol cleaning solution may comprise trans-1,2-dichloroethylene, cis-1-Chloro-3,3,3-trifluoropropene, and trans-1,3,3,3-tetrafluoropropene. The non-flammable aerosol cleaning solution may further comprising ethanol, or carbon dioxide, or both. For example, the non-flammable aerosol cleaning solution may comprise 35-40 wt. % trans-1,2-dichloroethylene, 30-35 wt. % cis-1-Chloro-3,3,3-trifluoropropene, and 20-25 wt. % trans-1,3,3,3-tetrafluoropropene.

According to certain aspects of the present disclosure, a non-flammable aerosol cleaning solution may comprise trans-1,2-dichloroethylene, cis-1-Chloro-3,3,3-trifluoropropene, and trans-1,3,3,3-tetrafluoropropene. The non-flammable aerosol cleaning solution may further comprising ethanol, or carbon dioxide, or both. For example, the non-flammable aerosol cleaning solution may comprise 35-40 wt. % trans-1,2-dichloroethylene, 30-35 wt. % cis-1-Chloro-3,3,3-trifluoropropene, and 20-25 wt. % trans-1,3,3,3-tetrafluoropropene. One advantage of this aerosol cleaning solution is that it has a lower global warming potential (GWP) compared to existing aerosol cleaning solutions.

HFO1233zd(E) is the trans isomer of 1-Chloro-3,3,3-trifluoropropene and could operate as an aerosol cleaning solution. However, HFO1233zd (E) is highly volatile and its boiling point is 19° C. (66° F.), which makes it difficult to handle at typical ambient temperatures. In fact, it may diminish the cleaning strength of other solvents with which it might otherwise be combined by removing heat through latent heat of vaporization. Table 3 shows a comparison of GWP for an aerosol cleaning solution where HFO1233zd(Z) has been substituted for a high GWP HFC245fa (non-flammable solvent) and HFO1234ze has been substituted for HFC134a (non-flammable propellant). These two substitutions reduced greenhouse gas (GHG) content and global warming potential (GWP) significantly.

TABLE 3
Comparison of global warming potentials
of different solvents and propellants.

| | | GWP IPCC 6th Assessment |
|---|---|---|
| HFO1233zd(Z) | Solvent | 0.454 |
| HFO1234ze | Propellant | 1.37 |
| HFC245fa | Solvent | 892 |
| HFC134a | Propellant | 1530 |
| Carbon dioxide | Propellant/Reference | 1 |

TABLE 4
Comparison of global warming potentials
of different solvents and propellants.

| | Aerosol w/HFO1233zd(Z) and HFO1234ze | | |
|---|---|---|---|
| | Formulation | Formulation | Formulation |
| | Weight (lbs.) | Weight (g) | Percentage |
| Ethanol | 0.030 lbs. | 13.61 g | 3.00% |
| trans -1,2-dichlororethylene | 0.612 lbs. | 176.43 g | 38.88% |
| HFO-1233zd(Z) | 0.108 lbs. | 150.29 g | 33.12% |
| HFO-1234ze | 0.225 lbs. | 102.10 g | 22.50% |
| Carbon Dioxide | 0.025 lbs. | 11.34 g | 2.50% |
| Total Liquid | 0.750 lbs. | 340.33 g | 75.00% |
| Total | 1.000 lbs. | 453.79 g | 100.00% |

According to certain aspects of the present disclosure, other formulas with varying ratios of flammable contents (e.g., ethanol and trans-1,2-dichloroethylene) to non-flammable contents (e.g., HFO-1233zd(Z), HFO-1234ze, and CO₂) may be formulated to achieve specific cleaning strengths and characteristics.

### Swelling Solvent.

In swelling applications, parts including silicone and urethane tubes can be assembled by temporarily enlarging (swelling) the tubes with a volatile solvent so that the tubes fit easily over male connectors. A tight gripping bond is formed when the solvent volatilizes and returns to its original shape. Flammable silicone solvents (e.g., hexamethyldisiloxane (HMDS)) and hydrocarbons (e.g., n-heptane) are typically used. However, because the solvent is released to the environment, non-PFAS (non-polyfluoroalkyl substances) solvents are desirable to environmentally conscious users. Further, because this technique is often used to assemble medical devices (critical applications) a non-flammable solvent like HFO1233zd(Z) is desirable to eliminate chances of fire in a factory making mission critical devices.

According to certain aspects of the present disclosure, a swelling solvent may comprise cis-1-Chloro-3,3,3-trifluoropropene. In some embodiments, the swelling solvent may further comprise heptane. For example, the swelling solvent may comprise 90-95 wt. % cis-1-Chloro-3,3,3-trifluoropropene and 5-10 wt. % heptane. In some embodiments, the swelling solvent may further comprise trans-1-Chloro-3,3,3-trifluoropropene. For example, the swelling solvent may further comprise 50-80 wt. % cis-1-Chloro-3,3,3-trifluoropropene and 20-50 wt. % trans-1-Chloro-3,3,3-trifluoropropene. In other embodiments, the swelling solvent may comprise hexamethyldisiloxane (HMDS).

TABLE 5
Comparison of swelling solvents.

| | | Solvents | | | | | | |
|---|---|---|---|---|---|---|---|---|
| | | | | 22% | 50% | 5% | 10% | |
| | | | | trans/ | trans/ | Heptane/ | Heptane/ | |
| Silicone | Time | | 100% | 78% | 50% | 95% | 90% | 100% |
| Tubing | (min) | Heptane | zd(Z) | zd(Z) | zd(Z) | zd(Z) | zd(Z) | HMDS |
| Tube Mass | 0 | 100% | 100% | 100% | 100% | 100% | 100% | 100% |
| (%) | 5 | 139% | 149% | 161% | 172% | 159% | 163% | 135% |
| | 10 | 167% | 177% | 192% | 212% | 187% | 200% | 158% |
| | 20 | 200% | 215% | 222% | 256% | 230% | 242% | 190% |
| Tube | 0 | 100% | 100% | 100% | 100% | 100% | 100% | 100% |
| Diameter | 5 | 118% | 112% | 113% | 118% | 114% | 116% | 113% |
| (%) | 10 | 129% | 117% | 119% | 125% | 122% | 126% | 122% |
| | 20 | 143% | 128% | 127% | 134% | 128% | 133% | 133% |
| Observations | 60 | 116% | 100% | 103% | 101% | 102% | 103% | 129% |
| (After 20 min | 80 | 110% | 99% | 101% | 100% | 100% | 101% | 121% |
| exposure) | 100 | 106% | N/A | N/A | N/A | N/A | N/A | 114% |
| | 140 | 101% | N/A | N/A | N/A | N/A | N/A | 107% |
| | Original | Y | Y | Y | Y | Y | Y | Y |
| | Shape | | | | | | | |
| | (Y/N) | | | | | | | |

### Liquid Oxygen Service Line Cleaning Fluid.

A strong non-flammable solvent is typically required for cleaning lines and vessels containing liquid oxygen (LOx). Any organic or remotely flammable material, traces of residue and particles could react with the LOx, which could result in a catastrophic explosion and failure. HFO1233zd(Z) is a strong solvent capable of removing such traces and it is completely non-flammable so poses no danger if traces are left behind. While HFO1233zd(E) can be used for this process, its low boiling point (as discussed above with respect to aerosol cleaning) makes it difficult to use.

Another potential use is for cleaning validation. Manufacturing operations may use less expensive organic or water-based cleaning chemistries to do most of the manufacturing, processing, machining, and drawing oil removal. However, regardless of how the parts are cleaned, the cleaning must be validated. A liquid oxygen service line cleaning fluid may comprising or consisting of HFO1233zd(Z) may be ideal for cleaning validation. The properties that make HFO1233zd(Z) a good solvent for cleaning also make it a good solvent for cleaning validation. Its strong solvency essentially or practically removes all traces of contaminants and previous cleaning chemistry, when a cleaning validation fluid containing HFO1233zd(Z) is flushed through the system of cleaned lines. The cleaning validation fluid that is flushed through is then evaporated, either leaving behind (or, more ideally, not leaving behind) any remaining non-volatile residue (NVR) or particles.

According to certain aspects of the present disclosure, a liquid oxygen service line cleaning fluid may comprise or consist of cis-1-Chloro-3,3,3-trifluoropropene.

### Carrier and Deposition Solvent.

According to certain aspects of the present disclosure, a carrier and deposition solvent may be used to apply solid pesticides application to inert (e.g., gypsum) particles to disperse the pesticide as a heavier-than-air powder. The solid nature of the pesticide provides a timed-release feature and some pesticides are available only as solids. For example, a nematodicide called Aldicarb is applied to gypsum substrate by dissolving it in methylene chloride, then mixing the solution with the gypsum to make a slurry. Methylene chloride is then vacuum evaporated from the slurry. Methylene chloride may not be desired due to certain of its properties, so there is potential interest in alternative solvents that may be more environmentally friendly.

According to certain aspects of the present disclosure, a carrier and deposition solvent may comprise cis-1-Chloro-3,3,3-trifluoropropene. The carrier and deposition solvent may be used to carry and deposit fluoropolymer (fluorinated acrylate) coatings.

The fluoropolymer coatings and lubricants may also comprise: perfluoropolyether (PFPE or Krytox), polychlorotrifluoroethylene (PCTFE), fluorinated polyacrylates, fluorinated polycarbonates, fluorinated polyesters, Polyvinylidene fluoride (PVDF), a homopolymer of perfluoro (4-vinyloxy-1-butene) (butenyl vinyl ether, BVE) produced through cyclopolymerization of this perfluorodiene monomer wherein the polymer backbone consists predominantly of five-membered (pentagonal) cyclic rings, with some six-membered (hexagonal) rings and fluoroethylene vinyl ether (FEVE).

According to certain aspects of the present disclosure, a carrier and deposition solvent may comprise cis-1-Chloro-3,3,3-trifluoropropene. In certain embodiments, the carrier and deposition solvent may comprise 1-Chloro-2,3,3-trifluoropropene (HFO1233yd). In certain embodiments, the carrier and deposition solvent may comprise both cis-1-Chloro-3,3,3-trifluoropropene and 1-Chloro-2,3,3-trifluoropropene. The carrier and deposition solvent may be used to carry and deposit solid pesticides onto inert particles. In some embodiments, the inert particles may be made of gypsum. The carrier and deposition solvent may be used to carry and deposit solid pesticides onto powders. The carrier and deposition solvent may be used to carry and deposit protective coatings onto seeds. The carrier and deposition solvent may be used to carry and deposit protective coatings onto electronics, such as circuit boards, semiconductor wafers, hard drives, and/or any other type of electronics surface. In some embodiments, the coating solution may be applied by dip coating a surface. In some embodiments, the coating solution may be applied by spin coating a surface. In some embodiments, the coating solution may be applied by spraying the coating onto a surface.

According to certain aspects of the present disclosure, a carrier solvent may comprise cis-1-chloro-3,3,3-trifluoropropene. The carrier solvent may be used to carry silicone.

### Metal Working Fluid.

Metal working fluids comprising volatile HFE7100 may be useful for high precision metal working because such metal working fluids can cool the process site without contaminating it with the oils, surfactants, lubricants, and anticorrosive additives found in typical metal processing. Metal working fluids made by substituting HFO1233zd(Z) are an effective low GWP, non-PFAS, non-flammable alternative to HFE7100 based metal working fluids.

According to certain aspects of the present disclosure, a metal working fluid may comprise cis-1-Chloro-3,3,3-trifluoropropene. The metal working fluid may be used for cooling cutting and drilling operations. The metal working fluid may further comprise dodecanoate. For example, the metal working fluid may comprise 95 to 99.9 wt. % cis-1-Chloro-3,3,3-trifluoropropene and 0.1 to 5% dodecanoate.

The various aspects and embodiments disclosed herein are not intended to be limiting. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

1. A solution for applying a coating, the solution comprising:
a fluoropolymer coating; and
a carrier and deposition solvent for the fluoropolymer coating, wherein the carrier and deposition solvent comprises cis-1-chloro-3,3,3-trifluoropropene.

2. The solution of claim 1, wherein the fluoropolymer coating comprises fluorinated acrylate.

3. The solution of claim 1, wherein the fluoropolymer coating comprises perfluoropolyether.

4. The solution of claim 1, wherein the fluoropolymer coating comprises polychlorotrifluoroethylene.

5. The solution of claim 1, wherein the fluoropolymer coating comprises a fluorinated carbonate.

6. The solution of claim 1, wherein the fluoropolymer coating comprises a fluorinated polyester.

7. The solution of claim 1, wherein the fluoropolymer coating comprises polyvinylidene fluoride.

8. The solution of claim 1, wherein the fluoropolymer coating comprises fluoroethylene vinyl ether.

9. The solution of claim 1, wherein the fluoropolymer coating comprises a homopolymer of perfluoro (4-vinyloxy-1-butene).

10. A method of making a coating solution, the method comprising:
dissolving a fluoropolymer coating into a carrier and deposition solvent comprising cis-1-chloro-3,3,3-trifluoropropene.

11. A method of using a coating solution, the method comprising:
applying a coating solution to a surface, the coating solution comprising a carrier and deposition solvent comprising cis-1-chloro-3,3,3-trifluoropropene and a fluoropolymer coating; and
evaporating the carrier and deposition solvent to form a coating on the surface.

12. The method of claim 11, wherein the surface is a hard drive.

13. The method of claim 11, wherein applying the coating solution to a surface is performed by dip coating.

14. The method of claim 11, wherein applying the coating solution to a surface is performed by spin coating.

15. The method of claim 11, wherein applying the coating solution to a surface is performed by spraying the coating.
